(19) United States
(12) Patent Application Publication
(10) Pub. No.: US 2025/0353511 A1
(43) Pub. Date: Nov. 20, 2025

(54) COMPUTER-IMPLEMENTED METHOD AND SYSTEM FOR ANALYZING DRIVING DATA OF AN EGO VEHICLE

(71) Applicant: Robert Bosch GmbH, Stuttgart (DE)

(72) Inventors: Christian Heinzemann, Vellmar (DE); Anne Von Vietinghoff, Renningen (DE); Jens Oehlerking, Stuttgart (DE); Martin Butz, Steinheim An Der Murr (DE); Martin Herrmann, Korntal (DE); Michael Rittel, Markgroeningen (DE); Thomas Heinz, Stuttgart (DE)

(21) Appl. No.: 19/196,986

(22) Filed: May 2, 2025

(30) Foreign Application Priority Data
May 17, 2024 (DE) 10 2024 204 581.0

(51) Int. Cl. B60W 50/04; B60W 50/00; B60W 60/00; G07C 5/02

(52) U.S. Cl. CPC B60W 50/04; B60W 60/0027; G07C 5/02; B60W 2050/0028; B60W 2554/404; B60W 2556/40

(57) ABSTRACT

A computer-implemented method for analyzing driving data of an ego vehicle. The driving data include trajectory data of the ego vehicle along a test route and of other road users in the surrounding region of the test route. A zone sequence is determined for each user. Based on the zone sequences of the users, a sequence of equivalence classes for observed behavior of the ego vehicle is determined with using an analysis model and a sequence of phases that differ in the occupancy of the zones by at least one user and/or in the equivalence class for the observed behavior of the ego vehicle. The observed behavior of the ego vehicle is assigned to at least one of provided abstract scenarios based on the sequence of phases.

### CROSS REFERENCE

The present application claims the benefit under 35 U.S.C. § 119 of Germany Patent Application No. DE 10 2024 204 581.0 filed on May 17, 2025, which is expressly incorporated herein by reference in its entirety.

### BACKGROUND INFORMATION

Autonomous and highly automated driving functions should ensure safe and correct driving behavior in a wide variety of traffic situations. This requires extensive testing with simulated or recorded driving data, which represent the journey of an ego vehicle along a test route along with a surrounding region of the test route in which other road users are present. It must be ensured that the driving data covers as many different scenarios as possible, in particular critical traffic situations that occur very rarely in reality. For this purpose, abstract test scenarios can be defined that describe the course of a scenario in a declarative form, for example by requiring a sequence of certain situations, but not specifying how these should actually occur. The description of such abstract scenarios typically comprises qualitative information about the traffic infrastructure, such as, e.g., “happens on a 4-arm intersection,” “at a zebra crossing,” etc., without reference to a specific geometric map. Therefore, many logical scenarios can be assigned to an abstract scenario, all of which fulfill the abstract description of the scenario, but differ from one another due to different geometric maps, different constellations of road users and/or due to a permissible variance in the specific implementation.

### SUMMARY

The present invention relates to a computer-implemented analysis of driving data of an ego vehicle, which are to be used for testing autonomous and/or highly automated driving functions. In particular, the extent to which the driving data cover a specified set of abstract scenarios is to be examined.

According to an example embodiment of the present invention, the driving data comprise at least trajectory data of the ego vehicle along a test route and trajectory data of at least one other road user in a surrounding region of the test route, wherein the trajectory data comprise position data for the particular user-ego vehicle or other road user—for a sequence of trajectory times. The analysis of the driving data is based on a set of abstract scenarios. In addition, a digital map is provided, which covers the test route and the surrounding region and on which at least the individual topological zones of a zone graph of the test route are geometrically located. Furthermore, an analysis model for the zone graph of the test route is provided. The analysis model makes possible a zone-based determination of equivalence classes for the behavior of the ego vehicle.

Such analysis models are typically used for zone-based behavior analysis of the ego vehicle within the framework of prediction and planning. The core idea of zone-based behavior analysis is to understand possible intentions of the ego vehicle in a traffic scene as a sequence of topological driving zones. For each of these driving zones, conflicting traffic flows are identified and represented as so-called position zones. In addition, important elements of the traffic infrastructure, such as, e.g., traffic signs, traffic lights, etc., whose existence and status must be known to the ego vehicle, are represented via so-called information zones. The resulting topological zone graph abstracts from specific geometric information and conditions of the real transport infrastructure and therefore has general validity to a certain extent.

In the paper M. Butz et al., “SOCA: Domain Analysis for Highly Automated Driving Systems,” 2020 IEEE 23rd International Conference on Intelligent Transportation Systems (ITSC), 2020, pp. 1-6, doi: 10.1109/ITSC45102.2020.9294438., the so-called SOCA method is presented. With the aid of the SOCA method, traffic situations are analyzed, with the aim of determining boundary conditions for or requirements for the behavior of an automated ego vehicle in the particular traffic situation. For this purpose, an abstract description of the traffic situation to be analyzed is initially generated, for which zone graphs are used. A zone graph abstracts the traffic situation to be analyzed by representing the real road situation by a corresponding abstract traffic infrastructure element (static road geometry) having different zones that are relevant for the driving intention of the ego vehicle but are initially specified neither with regard to their size nor with regard to their position. The different zones can represent different map regions, possible traffic flows, objects, etc. On the basis of this abstract description of the traffic situation, the possible developments or the behavior of the road users involved are then determined and morphologically analyzed in order to determine boundary conditions for the behavior of the ego vehicle in the analyzed traffic situation. It is noteworthy that the results or boundary conditions obtained in this way initially apply to all traffic situations with the same zone graph. A specification is not performed until the results are data-loaded with the situation-specific parameters of the analyzed traffic situation.

In the case of the driving data analysis in question here, both the test route of the ego vehicle and the underlying geometric map are specified by the driving data to be analyzed. On the basis of this information, the individual zones of a zone graph—as would typically be used for zone-based behavioral analysis—can be defined and geometrically located in a digital map. This zone graph then represents a specific manifestation, i.e. an instance, of a topological zone graph.

The analysis model provided can, for example, be a so-called “Zwicky box,” as used within the framework of the SOCA method for behavioral analysis. A Zwicky Box models, among other things, the external influences, such as, e.g., traffic light status, and system states, such as, e.g., speed, that the ego vehicle must take into account in order to make a decision about a behavior. With the aid of the Zwicky Box, equivalence classes are identified that describe under which conditions the ego vehicle should show which behavior. The SOCA method guarantees that the partitioning of the decision space into equivalence classes is complete and consistent. In this connection, complete means that every possible combination of external influences and system states is assigned to at least one equivalence class, and consistent means that every possible combination of external influences and system states is assigned to at most one equivalence class.

According to the present invention, it has been recognized that a zone-based behavior analysis, such as, e.g., the SOCA method, can also be used to analyze test data for an automated driving function with regard to the coverage of specified test scenarios. With the aid of a zone-based behavior analysis, the abstract scenarios underlying the recorded driving data can be determined. This makes it possible to ascertain which abstract scenarios are covered by a set of test data.

According to an example embodiment of the present invention, a zone sequence is initially determined for each user, i.e., the sequence of zones of the digital map that the particular user—the ego vehicle and the at least one other user—have passed through. For this purpose, the digital map and the trajectory data of the individual users contained in the recorded driving data are used. Then, a sequence of equivalence classes is determined for the observed behavior of the ego vehicle. For this purpose, the zone sequence of the ego vehicle is analyzed with the aid of the analysis model, taking into account the zone sequences of the other users. This then determines a sequence of phases for the journey of the ego vehicle. The individual phases of this sequence differ in the occupancy of the zones by at least one user and/or in the equivalence class for the observed behavior of the ego vehicle. On the basis of the sequence of phases determined in this way, the observed behavior of the ego vehicle, i.e. the recorded journey of the ego vehicle, is assigned to at least one of the provided abstract scenarios.

In a preferred embodiment of the present invention, the trajectory data are evaluated and processed point by point, i.e., the position data of the respective users are analyzed and processed separately for each trajectory time step.

In this case, the zone sequence for a user can be ascertained very easily by using the corresponding position data for each trajectory time step to determine in which zone of the digital map the user was located.

Advantageously, according to an example embodiment of the present invention, the analysis of the zone sequences is also carried out point by point. For each trajectory time, an equivalence class is determined for the observed behavior of the ego vehicle.

The zone sequences of the individual users and the sequence of equivalence classes for the observed behavior of the ego vehicle can then be easily combined point by point, in order to ascertain the sequence of phases that differ in the occupancy of the zones by at least one user and/or in the equivalence class for the observed behavior of the ego vehicle.

In addition to the trajectory data of the user, the driving data to be analyzed usually comprise further information about the observed traffic scene, such as, e.g., traffic light states, road conditions, weather conditions, etc. Advantageously, the analysis model takes these additional driving data into account when determining the sequence of equivalence classes for the observed behavior of the ego vehicle.

As mentioned above, the analysis according to the present invention can be used to determine whether the recorded driving data already cover certain abstract scenarios. In particular, if the present invention is to be used at design time within the framework of a safeguarding process for an autonomous or highly automated driving function, it proves to be advantageous if the provided set of abstract scenarios fulfills a specified completeness criterion.

If the abstract scenarios are described at the topological level, based on the topological zones of a zone graph, then existing automaton-based coverage measures, such as state coverage, transition coverage, or path coverage, can be used as completeness criteria. For example, analogous to state coverage in automata, phase coverage could be required in such a way that every possible phase occurs at least once in any abstract scenario of the provided set. Analogous to path coverage in automata, it could be required that the abstract scenarios of the provided set cover every possible sequence of phases.

In one example embodiment of the present invention, at least some of the provided abstract scenarios are determined as a defined sequence of phases with the aid of the analysis model. In this case, the sequence of phases determined during the analysis of the driving data can simply be compared with the previously defined phase sequences of the provided abstract scenarios, in order to check whether the driving data cover one of the specified abstract scenarios and, if so, which one.

According to an example embodiment of the present invention, another possibility is to provide the set of abstract scenarios in the form of a generative model of a corresponding scenario space. This offers the advantage that the possible scenarios do not have to be explicitly listed.

In this case, for the assignment of the observed behavior of the ego vehicle to at least one scenario of the provided scenario space, it is checked whether the sequence of phases determined during the analysis of the driving data is “contained” in the generative model. For this purpose, the generative model is converted into a monitor form, which can then be used to carry out a so-called membership test.

With the aid of the method according to the present invention, it is possible to reliably assess how well a set of driving data is suitable for testing an automated driving function if the tests are to cover a specified set of abstract test scenarios. The set of “observed” abstract scenarios determined within the framework of the analysis in accordance with the present invention of the driving data is put into relation to the total set of abstract scenarios provided. Here, the size of the subset of “observed” scenarios serves as the basis for evaluating the set of driving data.

According to an example embodiment of the present invention, it is particularly advantageous if the driving data are recorded and analyzed during the driving operation of the ego vehicle. In this case, the coverage of a specified set of test scenarios can be determined when recording driving data, e.g. during test drives and endurance runs. The present invention can also be used to analyze data of a fleet.

In addition to the computer-implemented method for analyzing driving data of an ego vehicle described above, the present invention also relates to a computer-implemented system for analyzing driving data of an ego vehicle. According to an example embodiment of the present invention, such a system comprises at least one storage medium for
driving data of an ego vehicle, wherein the driving data comprise at least trajectory data of the ego vehicle along a test route and at least trajectory data of at least one other road user in a surrounding region of the test route,
a set of abstract scenarios,
a digital map which covers the test route and the surrounding region and on which at least the individual topological zones of a zone graph of the test route are geometrically located, and
an analysis model for the zone graph of the test route for the zone-based determination of equivalence classes for the behavior of the ego vehicle.

In addition, such a system according to an example embodiment of the present invention comprises at least one evaluation module
for determining a zone sequence for each user—ego vehicle and other road users—with the aid of the digital map and on the basis of the respective trajectory data,
for determining a sequence of equivalence classes for the observed behavior of the ego vehicle with the aid of the analysis model and on the basis of the zone sequences of the users,
for determining a sequence of phases that differ in the zone occupancy of at least one user and/or in the equivalence class for the observed behavior of the ego vehicle, and
for assigning the observed behavior of the ego vehicle to at least one of the provided abstract scenarios on the basis of the sequence of phases.

### BRIEF DESCRIPTION OF THE DRAWINGS

Exemplary embodiments and advantageous further developments of the present invention are explained in more detail below in conjunction with the figures.

FIG. 1 shows a block diagram of a first example embodiment of the computer-implemented method according to the present invention for analyzing driving data of an ego vehicle.

FIG. 2A to 2C show Venn diagrams for illustrating the results of the analysis method according to the present invention in the form of sets of abstract scenarios that are described by a generative model.

### DETAILED DESCRIPTION OF EXAMPLE EMBODIMENTS

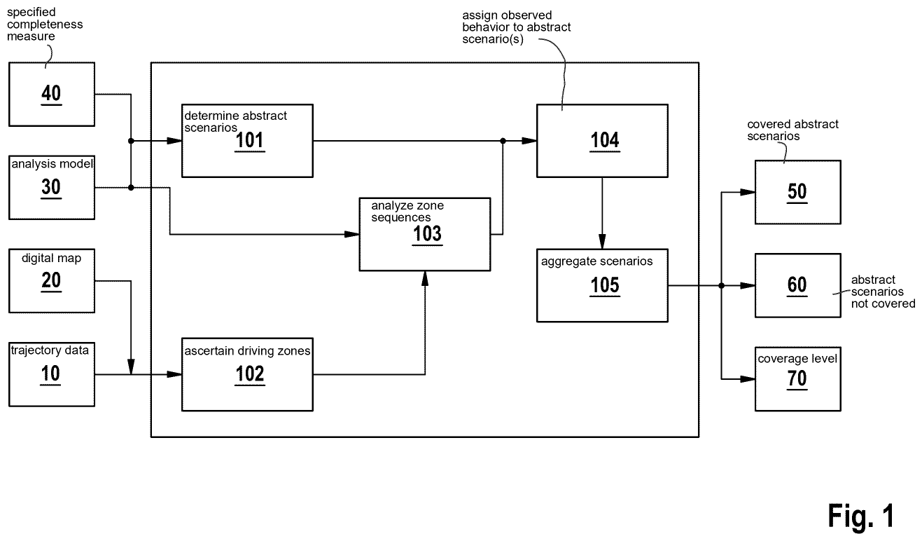

With the aid of the present invention, it is possible to automatically ascertain which abstract scenario underlies a specific scenario that is described by driving data. FIG. 1 illustrates the sequence of method steps of the method according to the present invention and in particular which information is required for the individual method steps (input) and is generated in the individual method steps (output).

A prerequisite for the applicability of the method according to the present invention is that the driving data 10 to be analyzed comprise trajectory data of the ego vehicle along a test route and trajectory data of at least one other road user in a surrounding region of the test route. Trajectory data typically comprise position data for the particular user-ego vehicle or other road user—for a sequence of trajectory times, but can also comprise further status data of the particular user at the individual trajectory times, such as, e.g., speed, orientation, etc. As a rule, the driving data 10 to be analyzed comprise, in addition to the trajectory data, further data that describe the observed traffic scene, e.g. information on the traffic infrastructure, road conditions, weather conditions, etc.

The method according to the present invention requires a digital map 20, which covers the test route of the ego vehicle together with a surrounding region and on which at least the individual topological zones of a zone graph of the test route are geometrically located. Such a digital map can be created, for example, using a method as described in German Patent Application No. DE 10 2023 209 189.5.

Furthermore, an analysis model 30 for the zone graph of the test route must be provided for the zone-based determination of equivalence classes for the behavior of the ego vehicle. In the exemplary embodiment of the present invention described here, the analysis model provided is a so-called “Zwicky box,” as used within the framework of the SOCA method for behavioral analysis. In principle, however, another formal model that describes the scenario space as a state machine could also be assumed.

Finally, the method according to the present invention requires the provision of a set of abstract scenarios that are to be recognized in the driving data to be analyzed.

In the method variant described here, such abstract scenarios are determined in advance in method step 101. For this purpose, the traffic scene specified by the driving data 10 is analyzed with the aid of the analysis model 30. A specified completeness measure 40, such as, e.g., state coverage, path coverage, etc., is taken into account. For the determination of the abstract scenarios with the aid of the analysis model 30, a method as described in the German Patent Application No. DE 10 2020 207 909.9 can be used, for example. Method and the coverage measure the possible abstract scenarios for the present geometry are determined. The abstract scenarios determined in method step 101 are stored here in a database.

The method according to the present invention provides that a zone sequence is determined for each user with the aid of the digital map 20 and on the basis of the trajectory data 10. This is carried out in method step 102. In this method step 102, for each trajectory time contained in the driving data 10, it is ascertained for both the ego vehicle and the other users in which driving zone the ego vehicle was located and which other users were located in which driving zones/position zones. Since other users can of course also be in the driving zones of the ego vehicle, driving zones are always to be regarded as position zones. For this purpose, the information about the geometric location of the zones in the digital map is used. This provides a zone sequence for each user in the form of occupied zones at the respective trajectory times.

According to the present invention, the zone sequences ascertained for the individual users in method step 102 are analyzed in method step 103 with the aid of the analysis model in order to determine a sequence of equivalence classes for the observed behavior of the ego vehicle. The other information contained in the driving data is also evaluated. The Zwicky box used here as an analysis model determines the appropriate equivalence classes of the behavioral analysis. Depending on the nature of the behavior analysis, either a required behavior or a plurality of permitted behaviors for the ego vehicle can be derived. The evaluation is performed for each time step, so that a sequence of equivalence classes is obtained for each trajectory time. This sequence of equivalence classes is now combined point by point with the zone sequences of the users determined in method step 102 in order to obtain a phase for each trajectory time. In order to obtain a sequence of phases that differ in the occupancy of the zones by at least one user and/or in the equivalence class for the observed behavior of the ego vehicle, all consecutive, identical phases are now removed, so that in each case between two phases at least one zone occupancy of at least one road user changes or the equivalence class of the ego vehicle changes.

In method step 104, the observed behavior of the ego vehicle is assigned to at least one of the abstract scenarios provided in method step 101 on the basis of the sequence of phases determined in method step 103. For this purpose, the scenario identified by the sequence of phases is searched in the database created in method step 101. In order to speed up the search, techniques such as, e.g., hashing can be used. In this method step 104, it may happen that individual scenarios cannot be clearly distinguished or assigned. In this case, both scenarios can be marked as recognized and the data trace can be marked in each case as an instance of each of the two abstract scenarios.

In the exemplary embodiment described here, finally, in a method step 105, all scenarios observed in the driving data 10 are aggregated in order to ascertain which abstract scenarios of the set determined in method step 101 were covered—designated here with 50—and which abstract scenarios of this set were not covered—here designated with 60. In addition, a coverage level 70 for the analyzed driving data 10 can be determined from the ratio of the two sets 50 and 60. In the exemplary embodiment described here, only the scenarios contained in the database need to be checked and counted.

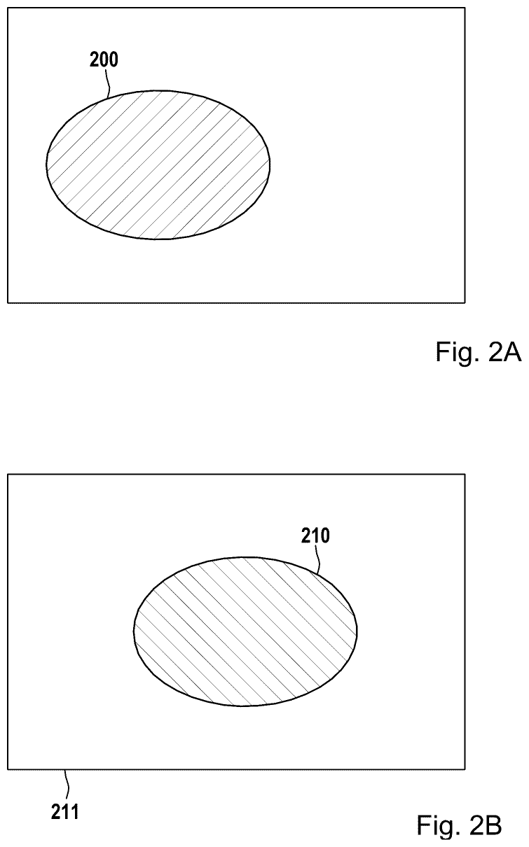

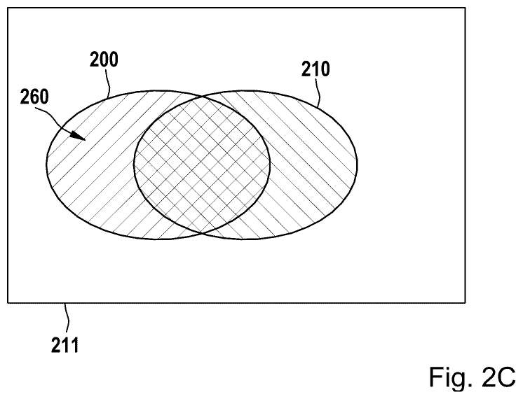

In contrast to the method step 101 described above, the set of abstract scenarios can also be provided in the form of a generative model of a corresponding scenario space, for example in the form of a regular language or a non-deterministic finite automaton. These two forms of representation can be converted into one another equivalently. This offers the advantage that the possible scenarios do not have to be explicitly listed. What is important in this case is that the regular language must either be finite or a maximum length k must be defined for the scenarios, where k represents the maximum word length of the regular language. Otherwise, coverage cannot be achieved or the algorithm does not terminate. FIG. 2A shows a Venn diagram of a set of abstract scenarios A_{Scenario} 200 described in this way.

In this case, in method step 104 it must be checked whether the scenario observed in the analyzed driving data is “contained” in the generative model. For this purpose, the generative model is converted into a monitor form and then the scenario observed is fed into this monitor as a trace, phase by phase. The monitor then carries out a non-deterministic matching of the trace against the regular language/automaton, which is also called a membership test. One or more possible scenarios from the scenario space are maintained. The latter is particularly useful if two possible equivalence classes cannot be precisely distinguished due to a lack of information.

For the aggregation of the observed scenarios in method step 105, an automaton is learned from all observed scenarios by interpreting all scenarios observed in the analyzed driving data as traces of an unknown automaton. With the aid of these traces, an automaton A_{Trace} describing these traces is now learned. Conventional methods such as, e.g. the L* algorithm can be used for this purpose—see e.g.: Angluin, Dana. “Learning regular sets from queries and counterexamples.” Information and computation 75.2 (1987): 87-106.). FIG. 2B shows a Venn diagram of the set of observed scenarios 210 described by A_{Trace} along with the complement 211 of A_{Trace}.

For the determination of the coverage level 70, the complement 211 of the learned automaton A_{Trace} 210 is initially computed, and then the intersection A_{uncov} 260 with the regular language A_{Scenario} 200, i.e. A_{uncov}=A̅_̅{̅T̅r̅a̅c̅e̅}̅∩A_{Scenario}, is calculated. FIG. 2C represents the calculation formula graphically as a Venn diagram, since the automata A_{Trace} 210 and A_{Scenario} 200 in each case can be understood as sets of the scenarios they describe. If A_{uncov}=Ø, then the analyzed driving data cover all abstract scenarios defined by A_{Scenario} 200. If not, all of the A_{uncov} 260 described embodiments are scenarios that have not yet been covered. The existence of A_{uncov} 260 and the property that A_{uncov} 260 is also a regular language have been proven—see e.g. Lecture Notes: homepage.cs.uri.edu/faculty/hamel/courses/2014/spring2014/csc445/lecture-notes/ln445-03.pdf.

At this point it should be noted that with the aid of A_{uncov}′ additional test data can be optionally generated to cover scenarios not yet covered.

In a further embodiment of the present invention, a generative model in the form of a formal language L_{Scenario} is likewise used as the basis for describing the possible scenarios, i.e., for providing the set of abstract scenarios. L_{Scenario} can again be a regular language, but other formal languages defined by an alphabet, such as, e.g., context-free grammars, can also be used.

In this embodiment, the possible phases that occur in the scenario model are considered as letters of the alphabet of the formal language L_{scenario}. This is exploited during the identification or assignment of the observed scenarios in method step 104 by iteratively going through a trace t observed in the driving data and, for example, determining which scenarios are still possible on the basis of the processed prefix p_{0 . . . i} up to point in time i, by calculating the Brzozowski derivative (en.wikipedia.org/wiki/Brzozowski_derivative). The set of still possible scenarios is designated by S. If the set S becomes empty, the scenario is not contained in the model and represents a new scenario. As soon as only one possible scenario remains, i.e. |S|=1, it can be compared whether the suffix of s∈S corresponds to the suffix of t. If so, the scenario was successfully found.

The generative model of the scenario space is also used here for aggregating all observed abstract scenarios by gradually generating all possible prefixes pᵢ of scenarios of length i, i.e., beginnings of abstract scenarios with i phases. For each pᵢ In the list of observed scenarios, it is checked whether there is a scenario in the recorded traces si that starts with the prefix pᵢ. If not, all possible continuations of si are currently uncovered scenarios. Their number can optionally be determined by exhaustively enumerating them over the formal language L_{scenario} using the prefix pᵢ. If the scenarios not covered are only to be described, a Brzozowski derivative, e.g., can be used again.

In a further embodiment of the method according to the present invention, all possible abstract scenarios are initially enumerated and stored in a database. Then, method steps 102 and 103 are carried out as described in connection with FIG. 1.

However, for the identification of the observed behavior of the ego vehicle or for assigning this behavior to at least one of the provided abstract scenarios, the conditions of the individual phases of the abstract scenario are translated into atomic propositions or predicate logic formulas that can be evaluated to “true” or “false” on a trace. The atomic propositions can refer to both the zone graph and the Zwicky box from the behavioral analysis. Examples of atomic propositions are “vehicle-in-zone-x,” “traffic light_red,” etc. The sequence of phases is subsequently encoded into a temporal-logical formula, e.g. using signal temporal logic (STL)—see, for example, link.springer.com/chapter/10.1007/978-3-319-75632-5_5. An example of such a formula in STL might look like this:

```
F (
  situation_intersection_av_position(1,s1,v1,y) &&
  situation_intersection_subject_intention(1,s1,v1,m_g2_n) &&
  sel_situation_intersection_check(1,ebrake,ebrake,s1,v1,simg1_and_g2,no) &&
  sel_situation_intersection_check(1,moveon,moveon,s1,v1,simg1_and_g2,yes) &&
  F (
    situation_intersection_av_position(2,s1,v1,y) &&
    situation_intersection_subject_intention(2,s1,v1,m_g2_n) &&
    sel_situation_intersection_check(2,moveon,moveon,s1,v1,simg2,yes) &&
    sel_situation_intersection_check(2,ebrake,ebrake,s1,v1,simg2,yes) &&
    sel_situation_intersection_check(2,moveon,moveon,s1,v1,collision,yes) &&
    sel_situation_intersection_check(2,ebrake,ebrake,s1,v1,collision,no)
  )
)
```

At this point it should be noted that the use of other operators is also possible.

For the identification of which abstract scenario fulfills the present trace, established monitoring methods for STL can be used, e.g. the Breach Toolbox (Donzé, A., Ferrere, T. and Maler, O., 2013 July, “Efficient robust monitoring for STL,” in International Conference on Computer Aided Verification (pp. 264-279). Springer, Berlin, Heidelberg.).

This method variant proves to be particularly advantageous because the evaluation of temporal-logical formulas is also real-time capable, i.e. it can be undertaken during the recording of driving data.

In addition to the above explanations, the following advantages and extension possibilities of the present invention should be pointed out:

From the information ascertained according to the present invention about the abstract scenarios not covered, requirements for future test drives and/or scenarios to be simulated can be automatically derived, which represents a valuable contribution to the testing of automated driving functions.

In the analysis according to the present invention of driving data, abstract scenarios can also be identified that are not contained in the provided set of possible abstract scenarios or that are not described by the generative model. Such results can be used advantageously in order to improve the generative model describing the possible abstract scenarios and/or the underlying analysis model.

Optionally, assumptions about the behavior of other road users can be specified in the abstract scenarios. These assumptions can be carried out in parallel with scenario identification in order to find scenarios that do not match the model assumptions made. A method for verifying such assumptions for zone-based models is described in the German Patent Application No. DE 10 2020 215 545.3 and can be used analogously here.

The behavior analysis undertaken within the framework of the method according to the present invention can also refer to only part of the traffic situation, e.g. the correct interaction with pedestrians or the handling of 4-arm intersections. In this case, a plurality of sub-situations can also be evaluated with different analysis models and the method step 102 shown in FIG. 1 can be divided into a plurality of sub-steps. In a first sub-step, it could then be initially ascertained which sub-situations are to be evaluated for the current trace and which road users are relevant for this. In the following sub-steps, the actual behavioral analyses would then be undertaken using the corresponding analysis models.

In addition, there may also be dependencies between the parts of the traffic situation that influence the possible scenarios. The dependencies can then be resolved, e.g., via priorities, as described in Germany Patent Application No. DE 10 2023 201 983.3.

What is claimed is:

1. A computer-implemented method for analyzing driving data of an ego vehicle, wherein the driving data include at least trajectory data of the ego vehicle along a test route and at least trajectory data of at least one other road user in a surrounding region of the test route, wherein the trajectory data include position data for the ego vehicle or other road user, for a sequence of individual trajectory times, the method comprising the following steps:
providing for the analysis of the driving data: (i) a set of abstract scenarios, (ii) a digital map which covers the test route and the surrounding region and on which at least individual topological zones of a zone graph of the test route are geometrically located, and (iii) an analysis model for the zone graph of the test route for a zone-based determination of equivalence classes for behavior of the ego vehicle;
determining, using the digital map and based on the trajectory data, a zone sequence for each user;
determining, using the analysis model, a sequence of equivalence classes for observed behavior of the ego vehicle based on the zone sequences of the users;
determining a sequence of phases which differ: (i) in occupancy of the zones by at least one user and/or (ii) in the equivalence class for the observed behavior of the ego vehicle; and
assigning the observed behavior of the ego vehicle to at least one of the provided abstract scenarios based on the the sequence of phases.

2. The method according to claim 1, wherein the zone sequences for the individual users are determined by determining in each case the zones in which the user was located at the individual trajectory times.

3. The method according to claim 1, wherein the determination of the sequence of equivalence classes for the observed behavior of the ego vehicle is also based on further driving data.

4. The method according to claim 2, wherein the sequence of equivalence classes for the observed behavior of the ego vehicle is determined by determining an equivalence class for each of the individual trajectory times.

5. The method according to claim 4, wherein the sequence of phases is determined by combining the zone sequences of the individual users and the sequence of equivalence classes for the observed behavior of the ego vehicle, for the individual trajectory times.

6. The method according to claim 1, wherein the provided set of abstract scenarios fulfills a specified completeness criterion.

7. The method according to claim 1, wherein at least some of the provided abstract scenarios are determined using the analysis model as a defined sequence of phases.

8. The method according to claim 1, wherein the set of abstract scenarios is provided in the form of a generative model of a corresponding scenario space.

9. The method according to claim 8, wherein, for the assignment of the observed behavior of the ego vehicle to at least one scenario of the provided scenario space, a membership test is performed using a monitor form of the generative model.

10. The method according to claim 1, wherein a set of the driving data is evaluated based on the analysis by determining the set of abstract scenarios to which an observed behavior of the ego vehicle can be assigned as a subset of the provided set of abstract scenarios and, based on the subset, determining a measure of an extent to which the set of driving data covers the provided set of abstract scenarios.

11. The method according to claim 1, wherein the driving data are recorded and analyzed during a driving operation of the ego vehicle.

12. A computer-implemented system for analyzing driving data of an ego vehicle, at least comprising:
at least one storage medium storing:
driving data of an ego vehicle, wherein the driving data include at least trajectory data of the ego vehicle along a test route and at least trajectory data of at least one other road user in a surrounding region of the test route,
a set of abstract scenarios,
a digital map which covers the test route and the surrounding region and on which at least individual topological zones of a zone graph of the test route are geometrically located, and
an analysis model for the zone graph of the test route for the zone-based determination of equivalence classes for the behavior of the ego vehicle; and
at least one evaluation module configured to:
determine a zone sequence for each user including the ego vehicle and other road users, using the digital map and based on respective trajectory data,
determine a sequence of equivalence classes for observed behavior of the ego vehicle using the analysis model and based on the zone sequences of the users,
determine a sequence of phases that differ: (i) in zone occupancy of at least one user and/or (ii) in the equivalence class for the observed behavior of the ego vehicle, and
assign the observed behavior of the ego vehicle to at least one of the provided abstract scenarios on the basis of the sequence of phases.
